(19) United States
(12) Patent Application Publication
(10) Pub. No.: US 2023/0003626 A1
(43) Pub. Date: Jan. 5, 2023

(54) CRACK ESTIMATION DEVICE, CRACK ESTIMATION METHOD, CRACK INSPECTION METHOD, AND FAILURE DIAGNOSIS METHOD

(71) Applicant: Mitsubishi Electric Corporation, Tokyo (JP)

(72) Inventors: Norihiko HANA, Tokyo (JP); Masao AKIYOSHI, Tokyo (JP); Kenji AMAYA, Tokyo (JP)

(73) Assignee: Mitsubishi Electric Corporation, Tokyo (JP)

(21) Appl. No.: 17/781,708

(22) PCT Filed: Jan. 22, 2020
(86) PCT No.: PCT/JP2020/002038

§ 371 Date: Jun. 2, 2022

(51) Int. Cl. G01N 3/08

(52) U.S. Cl. CPC G01N 3/08; G01N 2203/0017; G01N 2203/006

(57) ABSTRACT

This crack estimation device includes: a data determination unit which determines a shape model of a target structure to be inspected, and a crack occurrence plane and an observation plane in the shape model; an estimation data calculation unit which outputs an estimation model for estimating a state of the crack occurrence plane from a state of the observation plane, on the basis of a matrix that associates, with each other, the state of the crack occurrence plane and the state of the observation plane, obtained through numerical analysis of a structural analysis model generated from the shape model; and a crack estimation unit which estimates a state of a crack at the crack occurrence plane on the basis of the estimation model and a measurement value for the target structure actually measured at the observation plane.

### TECHNICAL FIELD

The present disclosure relates to a crack estimation device, a crack estimation method, a crack inspection method, and a failure diagnosis method.

### BACKGROUND ART

In general, for a crack inside a structure such as an apparatus, inspection by visual checking cannot be performed. Thus, while such a crack is left not being recognized in normal inspection, the crack expands and this influences the life of the structure, leading to failure of the apparatus. Therefore, detecting a crack inside a structure is an important problem in failure diagnosis for apparatuses.

As methods for inspecting a crack inside a structure in a nondestructive manner, shape measurement on a structure surface, ultrasonic flaw detection, X-ray inspection, and the like are known (see, for example, Patent Document 1).

### CITATION LIST

### Patent Document

Patent Document 1: Japanese Laid-Open Patent Publication No. 2012-159477

### SUMMARY OF THE INVENTION

### Problems to be Solved by the Invention

In a case of using a nondestructive inspection method such as ultrasonic flaw detection or X-ray inspection, it is difficult to reduce the device size. In a case of using shape measurement on a structure surface, it is easy to reduce the size but it is difficult to measure a crack inside the structure.

The present disclosure has been made to solve the above problem, and an object of the present disclosure is to provide a crack estimation device that enables estimation for an internal crack using a small-sized device.

### Solution to the Problems

A crack estimation device according to the present disclosure includes: a data determination unit which determines a shape model of a target structure to be inspected, and a crack occurrence plane and an observation plane in the shape model; an estimation data calculation unit which outputs an estimation model for estimating a state of the crack occurrence plane from a state of the observation plane, on the basis of a matrix that associates, with each other, the state of the crack occurrence plane and the state of the observation plane, obtained through numerical analysis of a structural analysis model generated from the shape model; and a crack estimation unit which estimates a state of a crack at the crack occurrence plane on the basis of the estimation model and a measurement value for the target structure actually measured at the observation plane.

### Effect of the Invention

The crack estimation device according to the present disclosure makes it possible to estimate a crack inside a target structure from information obtained by measuring the shape of the structure surface, using a small-sized device.

### BRIEF DESCRIPTION OF THE DRAWINGS

FIG. 1 is an entire configuration diagram of a failure diagnosis device including a crack estimation device according to embodiment 1.

FIG. 2 is a flowchart showing an overall procedure for estimating dimensions of a crack according to embodiment 1.

FIG. 3 is a hardware configuration diagram of the crack estimation device according to embodiment 1.

FIG. 4 is a function configuration diagram of the crack estimation device according to embodiment 1.

FIG. 5 is a perspective view of a target structure in a state in which tensile loads are applied.

FIG. 6 is a perspective view of a target structure in a state in which bending moments are applied.

FIG. 7A illustrates division of a crack occurrence plane in a target structure according to embodiment 1.

FIG. 7B illustrates another example of division of a crack occurrence plane in a target structure according to embodiment 1.

FIG. 7C illustrates still another example of division of a crack occurrence plane in a target structure according to embodiment 1.

FIG. 8 illustrates division of an observation plane on a target structure according to embodiment 1.

FIG. 9 is a flowchart for performing step S02 in FIG. 2.

FIG. 10 shows a memory structure for storing information about displacement changes in a crack occurrence plane according to embodiment 1.

FIG. 11 shows a memory structure for storing information about strain changes in an observation plane according to embodiment 1.

FIG. 12 is a flowchart for executing step S04 in FIG. 2.

FIG. 13 is a perspective view of a target structure having another shape.

FIG. 14 illustrates the target structure having the other shape.

FIG. 15 shows a memory structure for storing information about displacement changes in an observation plane according to embodiment 2.

FIG. 16 shows a memory structure for storing information about angle changes in an observation plane according to embodiment 2.

FIG. 17 shows a memory structure for storing information about load changes in a crack occurrence plane according to embodiment 3.

FIG. 18 is a flowchart illustrating operation according to embodiment 5.

FIG. 19 is a flowchart illustrating operation according to embodiment 6.

### DESCRIPTION OF EMBODIMENTS

Hereinafter, the present disclosure will be described with reference to the drawings. In the drawings, the same or corresponding members and parts are denoted by the same reference characters, to give description.

### Embodiment 1

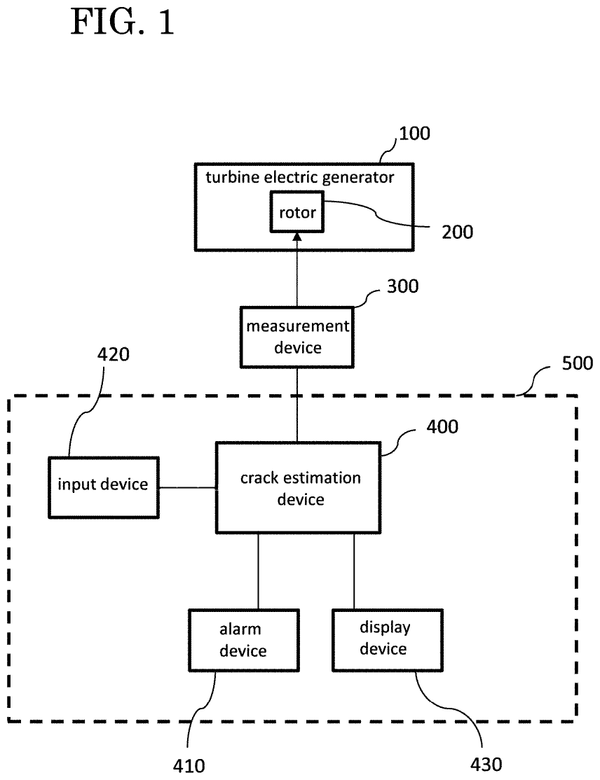

FIG. 1 is an entire configuration diagram of a failure diagnosis device 500 including a crack estimation device 400 according to the present embodiment. On the basis of learning data of the crack estimation device 400 and measurement data of a measurement device 300, the dimensions (position and size) of a crack inside a structure (target structure 01) forming a rotor 200 of a rotary electric machine in a turbine electric generator 100, for example, are estimated, and then, if the size of the crack is equal to or greater than a size that can cause failure, an alarm device 410 issues an alarm by means of sound or display. The crack estimation device 400 is connected to an input device 420 and a display device 430. In addition, the target structure 01 is measured by the measurement device 300.

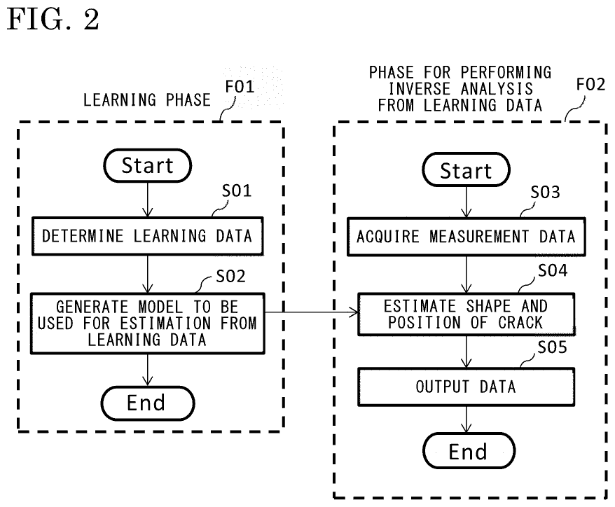

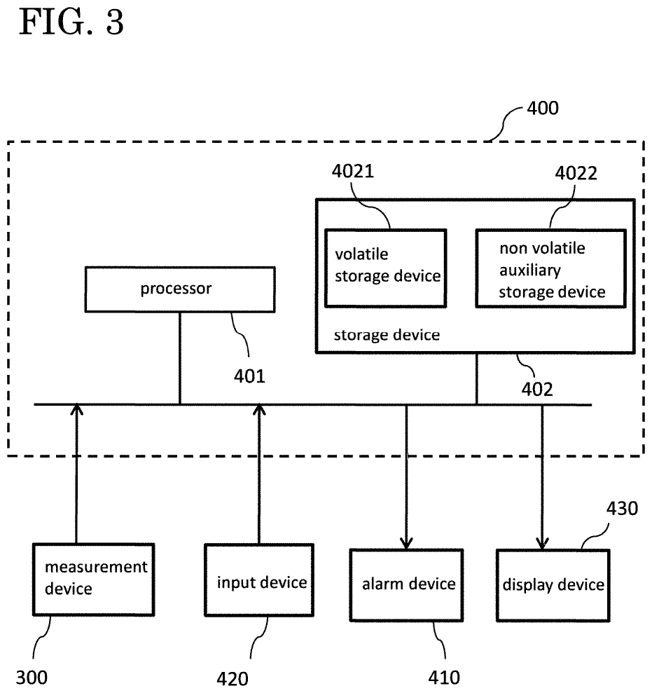

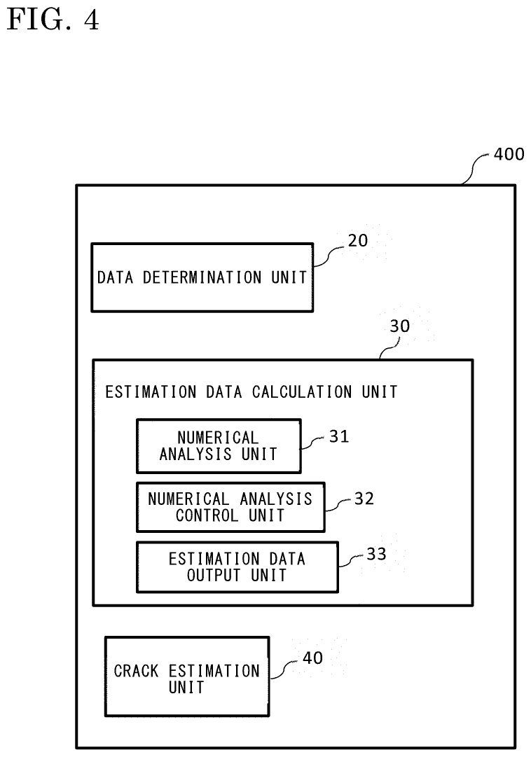

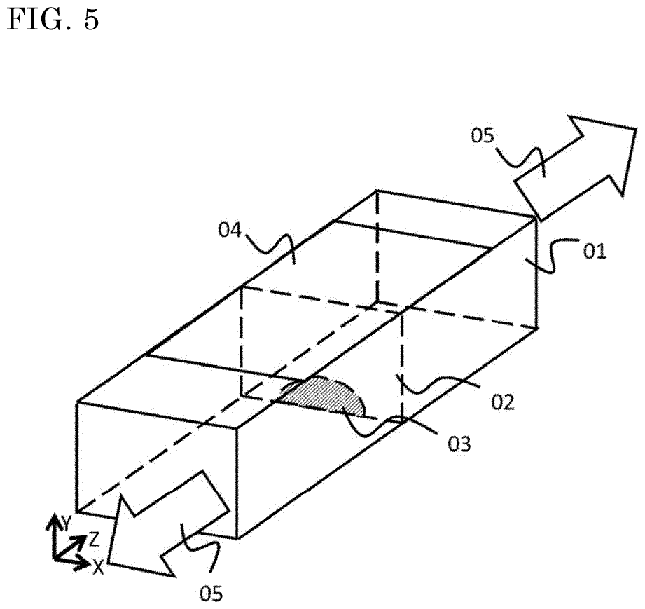

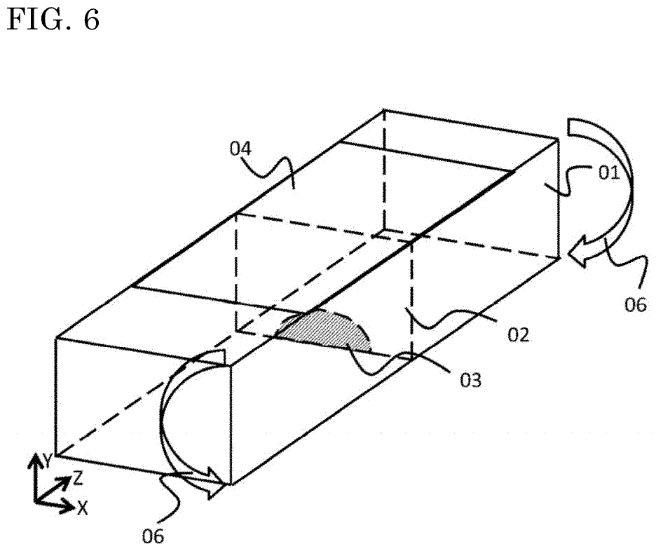

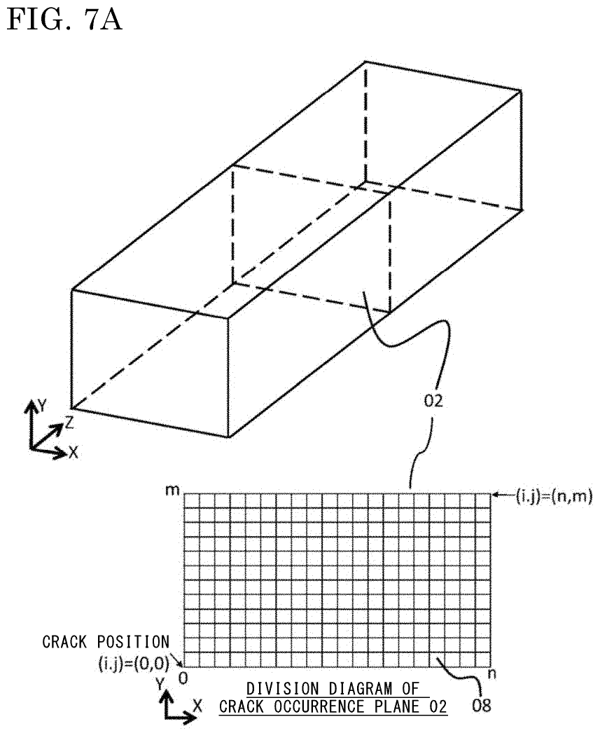

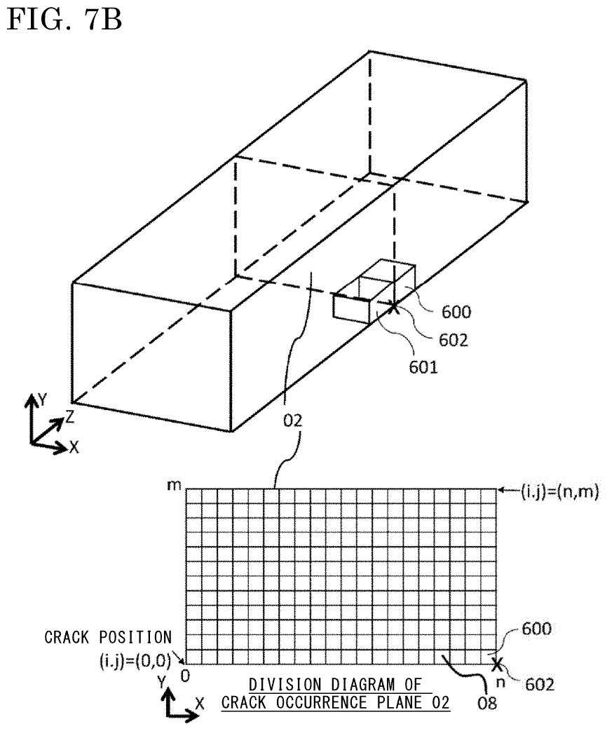

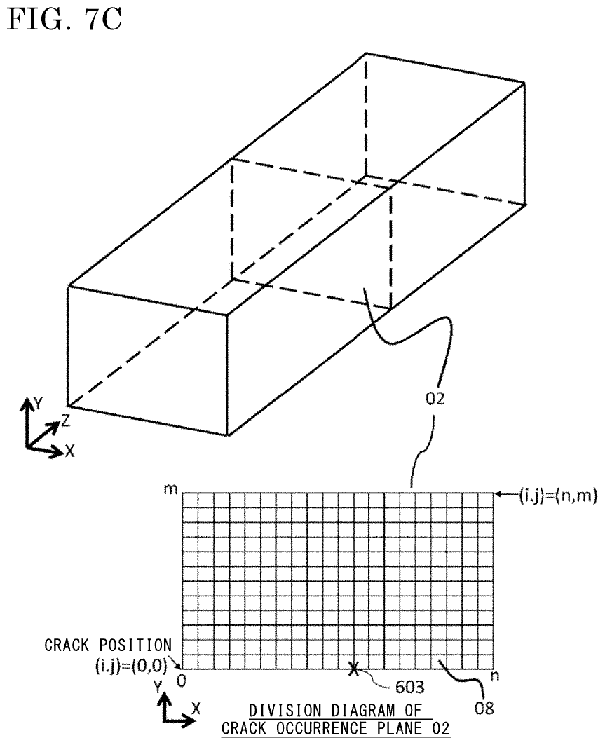

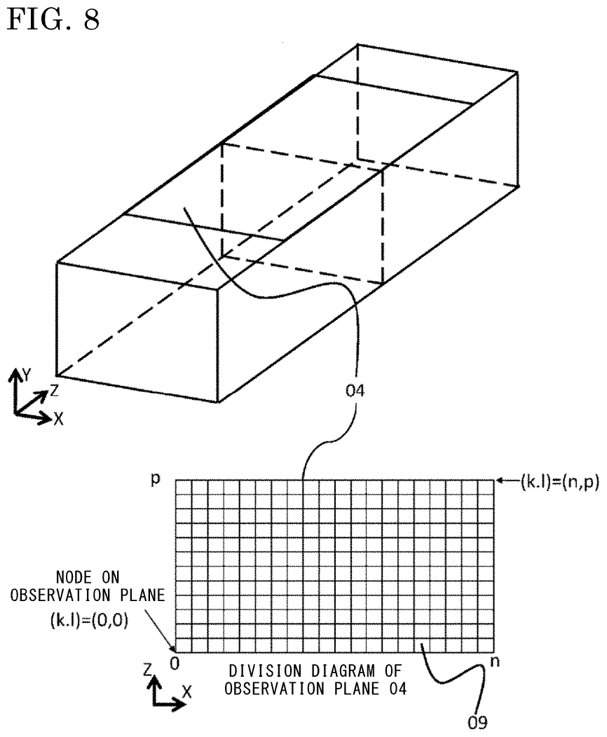

FIG. 2 is a flowchart showing an overall procedure for the crack estimation device 400 to estimate the dimensions of a crack inside the target structure 01, and step S01, step S02, and step S04 are performed by the crack estimation device 400. FIG. 3 is a hardware configuration diagram of the crack estimation device 400 shown in FIG. 1. FIG. 4 is a function configuration diagram of the crack estimation device shown in FIG. 1. FIG. 5 is a perspective view showing a state in which tensile loads are applied to the target structure 01. FIG. 6 is a perspective view showing a state in which bending moments are applied to the target structure 01. FIG. 7A to FIG. 7C illustrate division of a crack occurrence plane 02 in the target structure. FIG. 8 illustrates division of an observation plane 04 on the target structure 01.

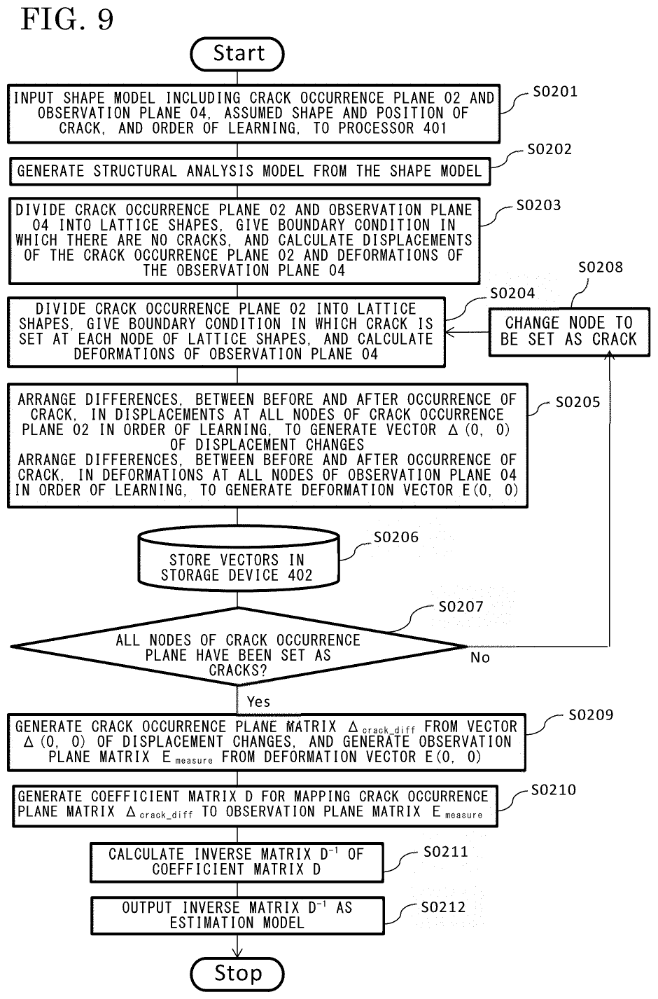

The flowchart in FIG. 2 shows the outline of data processing performed in the crack estimation device 400. FIG. 3 shows an example of hardware of a microcomputer in the crack estimation device 400 for executing the flowchart. The crack estimation device 400 is composed of a processor 401 and a storage device 402, and the storage device 402 is provided with a volatile storage device 4021 capable of primary storage, such as a random access memory, and a nonvolatile auxiliary storage device 4022 such as a read only memory or a flash memory. Instead of a flash memory, an auxiliary storage device of a hard disk may be provided. The processor 401 executes a program inputted from the storage device 402, thereby executing the flowcharts shown in FIG. 1, FIG. 9, etc. In this case, the program is inputted from the auxiliary storage device 4022 to the processor 401 via the volatile storage device 4021. The processor 401 may output data such as a calculation result to the volatile storage device 4021 of the storage device 402, or may store such data to the auxiliary storage device 4022 via the volatile storage device 4021. In the following description, the volatile storage device 4021 is assumed to be a primary storage unit.

When the processor 401 executes the flowchart shown in FIG. 2, as shown in FIG. 4, the function thereof can be divided into a plurality of function blocks such as a data determination unit 20, an estimation data calculation unit 30, and a crack estimation unit 40 in accordance with the execution content. In the following description, these functions will also be described together with steps in the flowchart.

In FIG. 2, a learning phase F01 is a phase in which learning data to be used for estimation is generated and learned. The learning phase F01 includes a step of determining a learning data condition (step S01), and a step of generating a model to be used for estimation, from learning data (step S02).

In FIG. 2, a phase F02 for performing inverse analysis from learning data is a phase in which, from measurement data acquired by the measurement device 300, estimation for the shape and the position of a crack is performed on the basis of the learning data generated in the learning phase F01, and the resultant data is outputted.

[Description of Learning Phase F01]

<Step of Determining Learning Data (Function as Data Determination Unit 20 in FIG. 4)>

In step S01 of determining learning data, as shown in FIG. 5, for the target structure 01 subjected to estimation, a part where occurrence of a crack 03 is assumed is estimated, and a crack occurrence plane 02 which is a part to be inspected is determined.

For example, the crack occurrence plane 02 may be determined as shown in (1) to (3) below. However, the determination method is not limited thereto.

(1) Obtain distribution of stress occurring in the target structure in advance through measurement or structural analysis.

(2) Select evaluation stress suitable for determining a crack occurrence part on the basis of the material and the stress distribution, and determine a point where the stress is maximized, as a crack occurrence part.

(3) Then, determine a plane that is perpendicular to the maximum principal stress direction at the occurrence part and corresponds to the crack occurrence part in the target structure, in a penetrating manner.

A surface that can be observed near the crack occurrence plane 02 is set as an observation plane 04 on which strain is to be measured. In this case, in FIG. 5, tensile loads 05 are applied to the target structure 01 at the time of inspection. As shown in FIG. 6, there is also a case where bending moments 06 are applied to the target structure 01 at the time of inspection. With the entirety or a part of the target structure 01 set as an inspection part, a shape model of the inspection part is generated. In a case of modeling the entirety of the target structure 01, deformation constraints applied to the target structure 01 besides the loads, temperature distribution, and the like are recognized as a boundary condition for structural analysis. In a case of modeling a part of the target structure 01, distribution of displacements or loads on the cutting plane is reflected as a boundary condition in structural analysis.

Next, as shown in FIG. 7A, the crack occurrence plane 02 in the shape model of the target structure 01 is divided into lattice shapes 08 forming unit planes (elements). In FIG. 7A, the plane is divided into n planes in the X direction and divided into m planes in the Y direction, and an intersect point of the divisional lattice lines is indicated as a position (i, j). Thus, the position (i, j) is represented by numbers from (0, 0) to (n, m). One of the lattice intersect points is set as a crack, and then the crack is sequentially moved on all the lattice intersect points. The order of this movement is determined at a stage in step S01.

In each structural analysis where the boundary condition for a crack at the crack occurrence plane 02 is changed, displacements calculated at the lattice points of the lattice shapes 08 of the crack occurrence plane 02 are stored in the determined order. A component of a displacement to be stored is such a component that a displacement of a part forming a crack at the crack occurrence plane 02 is greatest with respect to the loads or moments shown in FIG. 5 or FIG. 6.

As a method for moving a crack, a case of using a finite element method will be described as an example. As shown in FIG. 7B, there is a method of disconnecting a node 602 (connection) present between an element 600 and an element 601. That is, without sharing the node 602, the node 602 is divided into two nodes for the element 600 and the element 601 so that neither displacement nor force transfer occurs between the two nodes.

Alternatively, displacement of the crack occurrence plane is changed to a shape or a boundary condition equivalent to a case where a crack has occurred. For example, as shown in FIG. 7C, in an analysis model of ½ of the finite element method with the crack occurrence plane 02 set as a symmetric plane, the boundary condition for a node 603 corresponding to a crack is set such that there are no loads and there are no constraints on displacement. For the other nodes of the crack occurrence plane 02, a boundary condition is set such that there are no loads and Z-direction displacement is constrained to 0.

Next, as shown in FIG. 8, a range where surface deformation information to be used for estimating a crack is to be acquired is determined. This range is defined as an observation plane 04. In the present embodiment, strain is used as surface deformation. The observation plane 04 is also divided into lattice shapes 09 as in the crack occurrence plane 02. In FIG. 8, the plane is divided into n planes in the X direction and divided into p planes in the Z direction, and an intersect point of the divided lattice shapes 09 is indicated as a position (k, l). Thus, the position (k, l) is represented by numbers from (0, 0) to (n, p). In each structural analysis where the boundary condition for a crack at the crack occurrence plane 02 is changed, strains calculated at the lattice points of the observation plane 04 are stored in a determined order. The order of this storage is determined in step S01. A component of strain to be stored is such a component that strain is greatest with respect to the loads or moments shown in FIG. 5 or FIG. 6. As strain in a case where loads or moments are applied on two axes (e.g., Z axis and Y axis), principal strain, equivalent strain of Tresca, or equivalent strain of Mises, which is a parameter for evaluating loads on multiple axes or strain in a multi-axis stress field caused due to the structure, may be used.

The observation plane 04 is not limited to a group of intersect points (grid point group) of lattice shapes in a plane form shown in FIG. 8, and may be dispersed points or a point group in a part of the observation plane.

<Step of Generating Model to be Used for Estimation, from Learning Data (Function as Estimation Data Calculation Unit 30 in FIG. 4)>

Next, step S02 will be described in detail. In step S02, a structural analysis model to be used for estimating the shape and the position of a crack is generated from the learning data determined in step S01.

That is, while the shape and the position of a crack to be assumed are changed in the order determined in step S01, a structural analysis model generated from a shape model is numerically analyzed, and displacements of the crack occurrence plane 02 and deformations of the observation plane 04 are stored as vectors in the storage device 402. Then, analysis results of all the assumed crack shapes stored in the storage device 402 are represented in matrices.

Further, using the fact that displacements of the crack occurrence plane 02 and deformations of the observation plane 04 are in a linear relationship, an inverse matrix of a forward coefficient matrix between the crack occurrence plane matrix and the observation plane matrix is calculated.

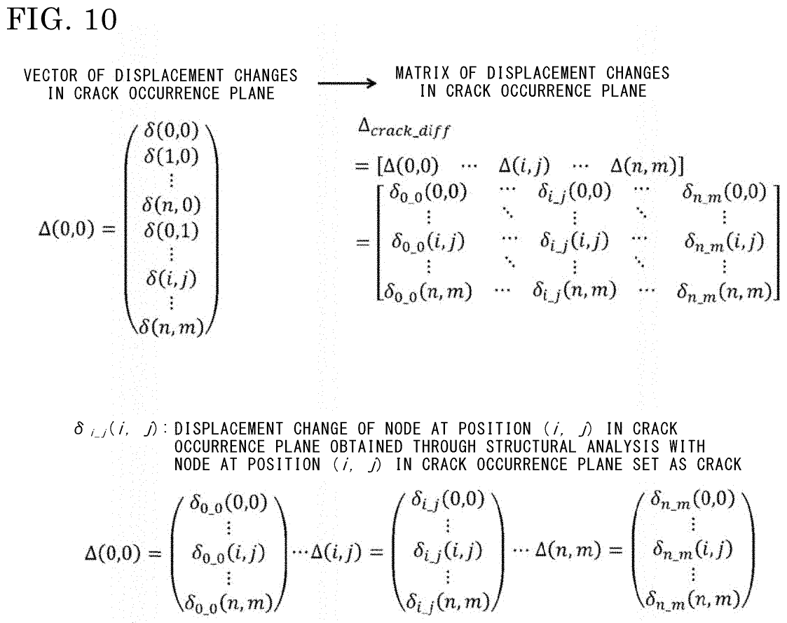

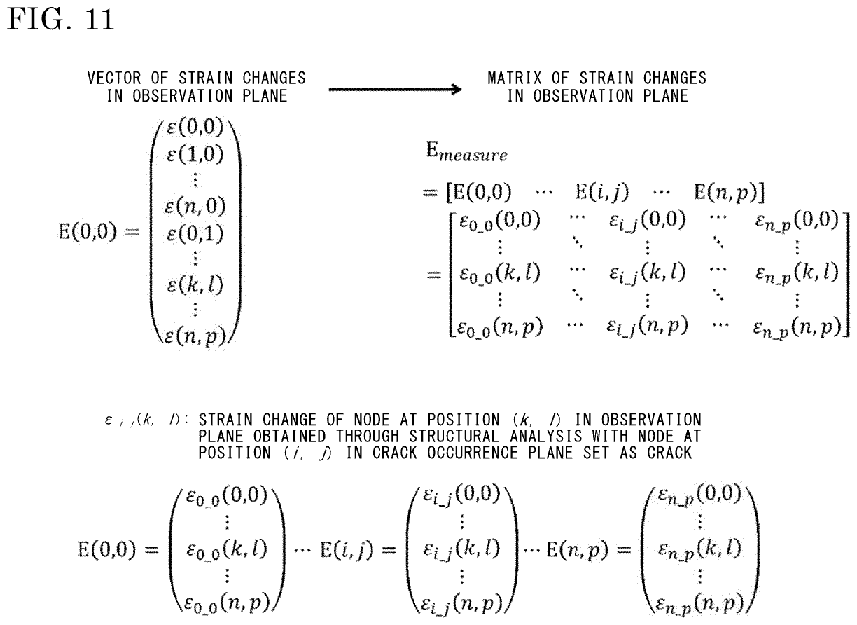

The detailed flowchart of step S02 is shown in FIG. 9. In addition, memory structures for generating matrixes from the vectors stored in the storage device 402, in step S02, are shown in FIG. 10 and FIG. 11. These memory structures are stored in the storage device 402.

<Function as Numerical Analysis Unit 31>

(1) In FIG. 9, in step S0201, the shape model including the crack occurrence part (crack occurrence plane 02) and the surface for measuring strain (observation plane 04), determined in step S01, the shape and the position of a crack assumed for learning, and the order of learning, are inputted to the processor 401. The processor 401 executes the following procedure.

(2) In step S0202, a structural analysis model is generated from the shape model through numerical calculation such as a finite element method.

<Function as Numerical Analysis Control Unit 32>

(3) In step S0203, the crack occurrence plane 02 and the observation plane 04 of the structural analysis model are each divided into a plurality of lattice shapes 08 as described above, a boundary condition in which there are no cracks is given, and displacements of the crack occurrence plane 02 and deformations of the observation plane 04 are calculated through structural analysis.

(4) In step S0204, the crack occurrence plane 02 of the structural analysis model is divided into a plurality of lattice shapes 08 as described above, a boundary condition in which a crack is set at each node included in the lattice shapes 08 is given, and deformations of the observation plane 04 are calculated through structural analysis.

(5) In step S0205, in each condition for setting a node as a crack, differences, between before and after occurrence of the crack, in displacements at all the nodes of the crack occurrence plane 02 are arranged in the order of learning, to generate a vector Δ(0, 0) of displacement changes in the crack occurrence plane 02. In addition, differences, between before and after occurrence of the crack, in deformations at all the nodes of the observation plane 04 are arranged in the order of learning, to generate a deformation vector E(0, 0) of strain changes in the observation plane 04 (see FIG. 10 described later).

(6) In step S0206, the vectors are stored in the storage device 402.

(7) In step S0207, whether or not structural analysis has been performed for all the nodes of the crack occurrence plane 02 set as cracks is determined. In order to set every node of the crack occurrence plane 02 as a crack, if structural analysis has not been performed for all the nodes set as cracks, in step S0208, the node to be set as a crack is changed, and structural analysis is performed by returning to step S0204. Then, in step S0206, the vectors are stored in the storage device 402.

(8) After structural analysis has been performed for all the nodes of the crack occurrence plane 02 set as cracks, in step S0209, the vector Δ(0, 0) of displacement changes in the crack occurrence plane 02, stored in the storage device 402, is arranged in the order of learning, to generate a crack occurrence plane matrix Δ_{crack_diff} which is a matrix of displacement changes in the crack occurrence plane 02.

(8-1) Specifically, as shown in the memory structure in FIG. 10, in the column vector of the vector Δ(0, 0) of displacement changes in the crack occurrence plane 02, displacement data at nodes of the crack occurrence plane 02 are arranged in the order determined in step S01. In the column vector of Δ(0, 0), δ(i, j) represents a displacement of a node at a position (i, j) in the crack occurrence plane 02.

(8-2) Further, with information of a crack occurrence position for learning set as a position (i, j) in the crack occurrence plane 02, a column vector of Δ(i, j) is generated, and each element in the column vector is represented by δi_j(i, j). Here, Δ(i, j) represents a displacement of the node at the position (i, j) in the crack occurrence plane 02 obtained through structural analysis with the node at the position (i, j) in the crack occurrence plane 02 set as a crack. Such column vectors are arranged in a row in the order of crack occurrence positions determined in step S01, to generate the crack occurrence plane matrix Δ_{crack_diff} of displacement changes in the crack occurrence plane 02.

(9) In addition, in step S0209, from the deformation vector E(0, 0) of strain changes at all the nodes of the observation plane 04 stored in the storage device 402, an observation plane matrix Eₘₑₐₛᵤᵣₑ which is a deformation matrix of strain changes in the observation plane is generated.

(9-1) Specifically, as shown in the memory structure in FIG. 11, in the column vector of the deformation vector E(0, 0) of strain changes in the observation plane, strain data at nodes of the observation plane 04 are arranged in the order determined in step S01. In the column vector of E(0, 0), ε(k, l) represents a strain of a node at a position (k, l) in the observation plane 04.

(9-2) Further, with information of a crack occurrence position for learning set at a position (i, j) in the crack occurrence plane 02, a column vector of E(i, j) is generated, and each element in the column vector is represented by εi_j(k, l). Here, E(i, j) represents a strain of the node at the position (i, j) in the crack occurrence plane 02 obtained through structural analysis with the node at the position (i, j) in the crack occurrence plane 02 set as a crack. Such column vectors are arranged in a row in the order of crack occurrence positions determined in step S01, to generate the observation plane matrix Eₘₑₐₛᵤᵣₑ of strain changes in the observation plane.

<Function as Estimation Data Output Unit 33>

(10) In step S0210 in FIG. 9, using the linear relationship between displacements of the crack occurrence plane 02 and deformations at all the nodes of the observation plane 04, a coefficient matrix D for mapping the crack occurrence plane matrix Δ_{crack_diff} to the observation plane matrix Eₘₑₐₛᵤᵣₑ is defined as Expression (1). Then, both sides of Expression (1) are multiplied from the left by an inverse matrix Δ_{crack_diff}⁻¹ of the crack occurrence plane matrix Δ_{crack_diff} as shown in Expression (2), whereby the coefficient matrix D is generated from the crack occurrence plane matrix Δ_{crack_diff} and the observation plane matrix Eₘₑₐₛᵤᵣₑ as shown in Expression (3).

[Mathematical 1]

DΔ_{crack}_{_{diff}}=Eₘₑₐₛᵤᵣₑ Expression (1)

[Mathematical 2]

DΔ_{crack}_{_{diff}}[Δ_{crack}_{_{diff}}]⁻¹=Eₘₑₐₛᵤᵣₑ[Δ_{crack}_{_{diff}}]⁻¹ Expression (2)

[Mathematical 3]

D=Eₘₑₐₛᵤᵣₑ[Δ_{crack}_{_{diff}}]⁻¹ Expression (3)

(11) In step S0211, an inverse matrix D⁻¹ of the coefficient matrix D generated in step S0210 is calculated.

(12) In step S0212, the inverse matrix D⁻¹ is outputted as an estimation model. In the present embodiment, displacement is used as a state of the crack occurrence plane 02, strain is used as a state of the observation plane 04, and the estimation model representing the relationship therebetween by the inverse matrix is described as an example. However, the estimation model is not limited to the inverse matrix described above. That is, the estimation model may be any model for estimating a state of the crack occurrence plane 02 from a state of the observation plane 04 on the basis of a matrix that associates, with each other, the state of the crack occurrence plane 02 and the state of the observation plane 04, obtained through numerical analysis of the structural analysis model.

[Phase F02 for Performing Inverse Analysis from Learning Data (Function as Crack Estimation Unit 40 in FIG. 4)]

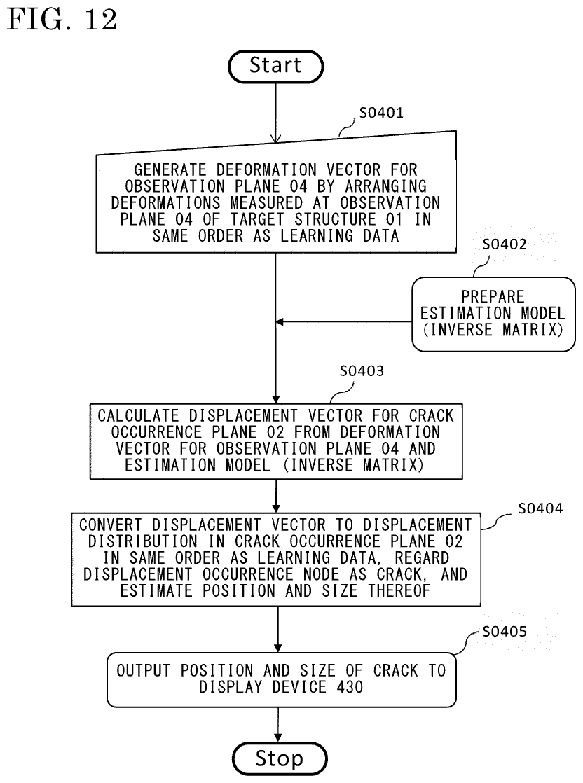

In step S03 of acquiring measurement data in FIG. 2, deformation of the observation plane 04 in the target structure 01 is measured by the measurement device 300. Here, strain is shown as an example. In measurement by the measurement device 300, a strain gauge, digital image correlation, or the like is used. Here, strain is measured in two conditions that there are no cracks inside and that a crack has occurred, and the difference therebetween is inputted to the crack estimation device 400. On the basis of the inputted measurement value, the crack estimation device 400 executes step S04 shown in FIG. 2. Specifically, the processor 401 executes a flowchart in FIG. 12 stored in the storage device 402, as follows.

(1) In step S0401 in FIG. 12, the measured strain data are arranged as a strain column vector similar to E(i, j) in the order determined in step S01, to generate a deformation vector for the observation plane 04. The measured strain data are at the same positions as the strain data for learning.

(2) Next, in step S0402, the estimation model (inverse matrix D⁻¹) calculated in the learning phase F01, which is the output in step S02 in FIG. 1, is prepared.

(3) In step S0403, a displacement vector for the crack occurrence plane 02 is calculated from the deformation vector for the observation plane 04 based on the measurement value in step S0401 and the estimation model (inverse matrix D⁻¹) calculated in the learning phase F01 and prepared in step S0402.

(4) In step S0404, the displacement vector for the crack occurrence plane 02 is arranged in the same order as the learning data determined in step S01, so as to be converted to displacement distribution in the crack occurrence plane. Then, a node at which displacement has occurred is regarded as a crack, and the position and the size thereof are determined. The result thereof is outputted as the position and the size of the crack shown in step S0405.

(5) In step 0405 (corresponding to step S05 in FIG. 2), the position and the size of the crack outputted in step S0404 are displayed as an inspection result on the display device 430.

As described above, in the present embodiment, it is possible to estimate a crack inside a target structure from information obtained by measuring the shape of the structure surface, using a small-sized device including an input device, a display device, a storage device, and a processor.

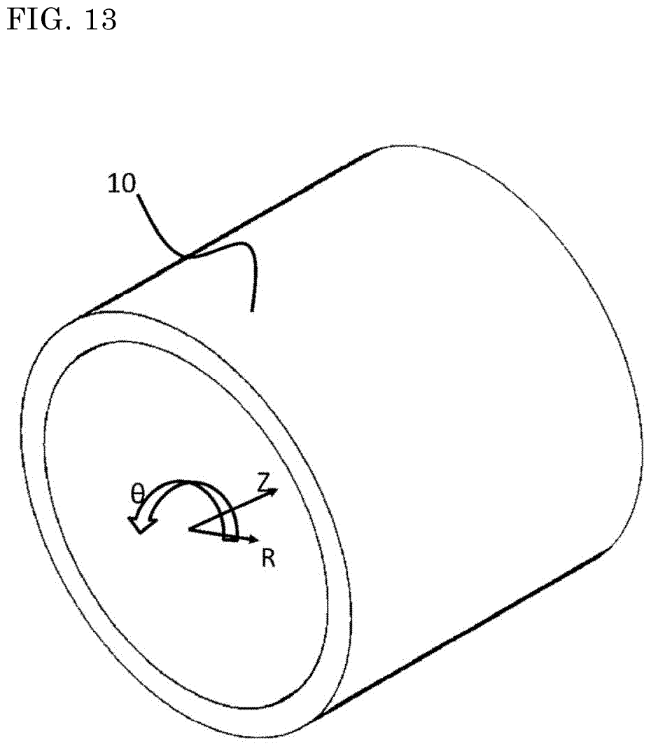

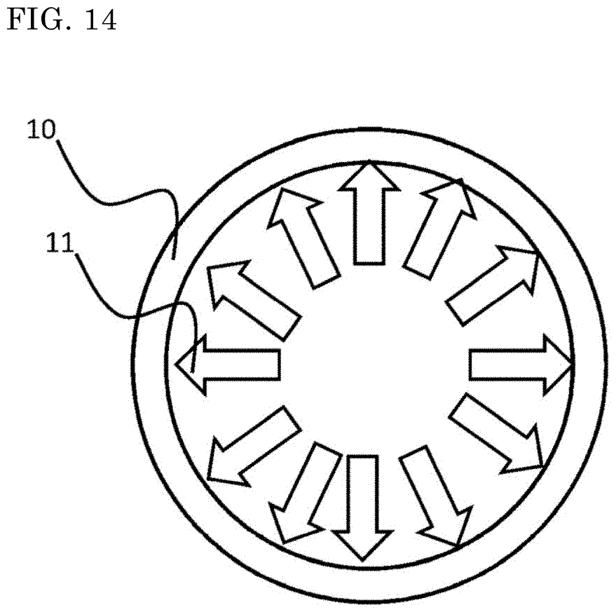

In the above description, the target structure 01 is represented in an orthogonal coordinate system having X axis, Y axis, and Z axis using a flat plate as a target. However, as shown in FIG. 13, in a case where the target structure 01 is a cylinder 10, a cylindrical coordinate system in which coordinates are represented by R axis, Z axis, and an angle θ, is also applicable. In this case, the X axis shown in FIG. 7A to FIG. 7C and FIG. 8 corresponds to the R axis, the Y axis corresponds to the angle θ, and the Z axis corresponds to the Z axis. A target cylinder structure in this case is a structure such as a shrink-fit part in which an internal pressure 11 is applied as shown in FIG. 14 and whose surface shape can change when a crack occurs inside.

One example of such a target structure to which the cylindrical coordinate system is applied is a shrink-fit part of a retention ring shrink-fitted to a rotor core at an end of a rotor of a rotary electric machine.

The inverse matrix D⁻¹ may be calculated through matrix operation for partial matrices of stiffness matrices representing displacement of the crack occurrence plane 02 and deformation of the observation plane 04, calculated through structural analysis in step S0203.

### Embodiment 2

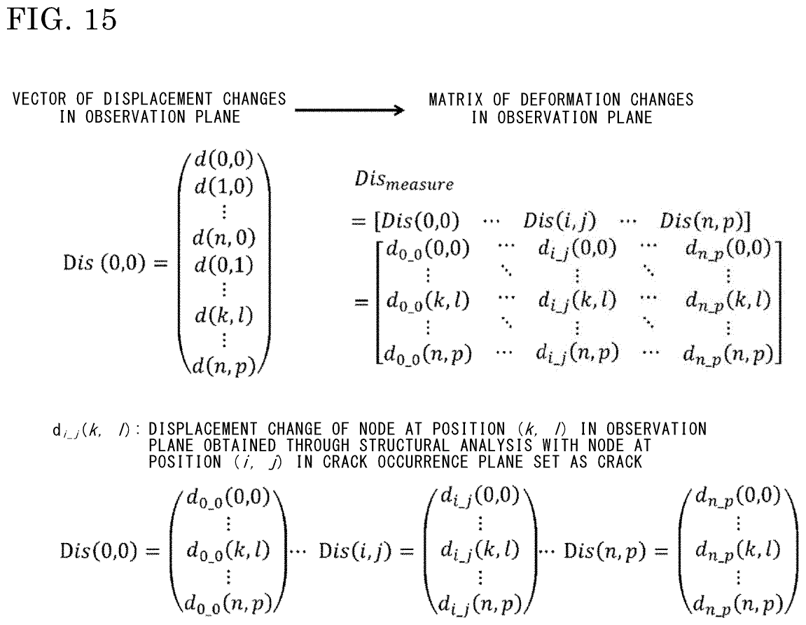

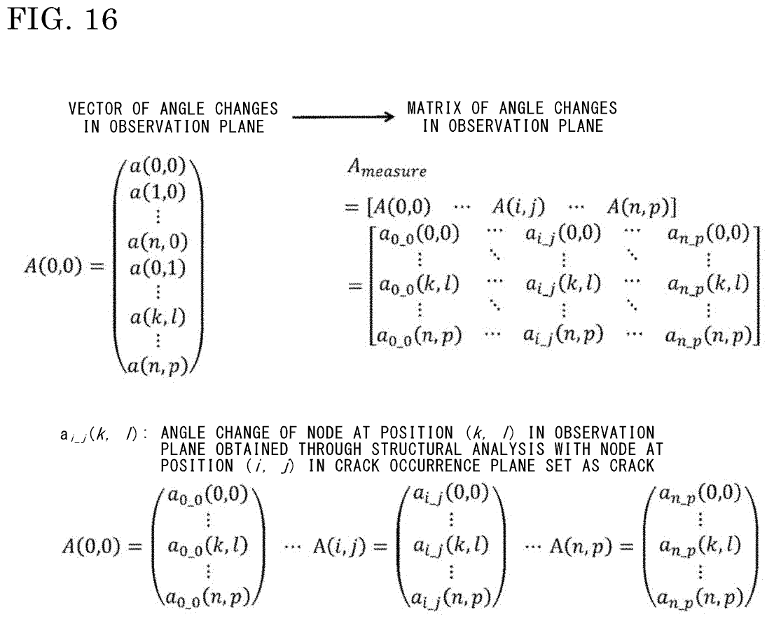

FIG. 15 shows a memory structure for storing information about displacement changes in the observation plane 04 according to embodiment 2. FIG. 16 shows a memory structure for storing information about angle changes in the observation plane according to embodiment 2.

With an inspection result indicating only presence/absence of a crack as described in embodiment 1, device stop and an operable period cannot be determined. However, it is impossible to learn all crack shapes desired to be detected. In order to solve this problem, an object is to estimate any internal crack position and size from changes in the observation plane 04 while learning less crack data efficiently.

Here, instead of strain change, displacement change or angle change is used as deformation of the observation plane 04, and in this case, only change in the method for generating the deformation vector for the observation plane 04 and the observation plane matrix will be described.

In the case of using displacement change, instead of the deformation vector E(0, 0) of strain changes shown in step S0205 in FIG. 9 or shown in FIG. 11, a column vector of a vector Dis(0, 0) of displacement changes is used as shown in FIG. 15. In the column vector Dis(0, 0), data of displacement changes at nodes of the observation plane 04 are arranged in the order determined in step S01. In FIG. 15, d(k, l) represents a displacement change of a node at a position (k, l) in the observation plane 04. Further, with information of a crack occurrence position for learning set as a position (i, j) in the crack occurrence plane 02, a column vector Dis(i, j) is generated, and each element in the column vector Dis(i, j) is represented by di_j(k, l). Here, di_j(k, l) represents a position change of the node at the position (k, l) in the crack occurrence plane 02 obtained through structural analysis with the node at the position (i, j) in the crack occurrence plane 02 set as a crack. Such column vectors are arranged in a row in the order of crack occurrence positions determined in step S01, to generate an observation plane matrix Disₘₑₐₛᵤᵣₑ which is a matrix of deformation changes in the observation plane.

In a case of using angle change, instead of the deformation vector E(0, 0) of strain changes shown in step S0205 in FIG. 9 or shown in FIG. 11, a column vector of a vector A(0, 0) of angle changes is used as shown in FIG. 16. In the column vector A(0, 0), angle change data at nodes of the observation plane 04 are arranged in the order determined in step S01. In FIG. 16, a(k, l) represents an angle change of a node at a position (k, l) in the observation plane 04. Further, with information of a crack occurrence position for learning set as a position (i, j) in the crack occurrence plane 02, a column vector A(i, j) is generated, and each element in the column vector A(i, j) is represented by ai_j(k, l). Here, ai_j(k, l) represents an angle change of the node at the position (k, l) in the crack plane obtained through structural analysis with the node at the position (i, j) in the crack occurrence plane 02 set as a crack. Such column vectors are arranged in a row in the order of crack occurrence positions determined in step S01, to generate an observation plane matrix A measure which is a matrix of angle changes in the observation plane 04.

As described above, by using the above means, operation for generating learning data corresponding to all shapes of cracks that can occur in a crack occurrence plane can be automated, and it is possible to estimate any internal crack position and size from changes in the observation plane while learning less crack data efficiently. Further, as deformation of the observation plane, not only strain change but also displacement change and angle change can be used, whereby the kinds of measurement methods can be increased and measurement can be performed in a shorter time and with higher accuracy than in a case of strain measurement.

### Embodiment 3

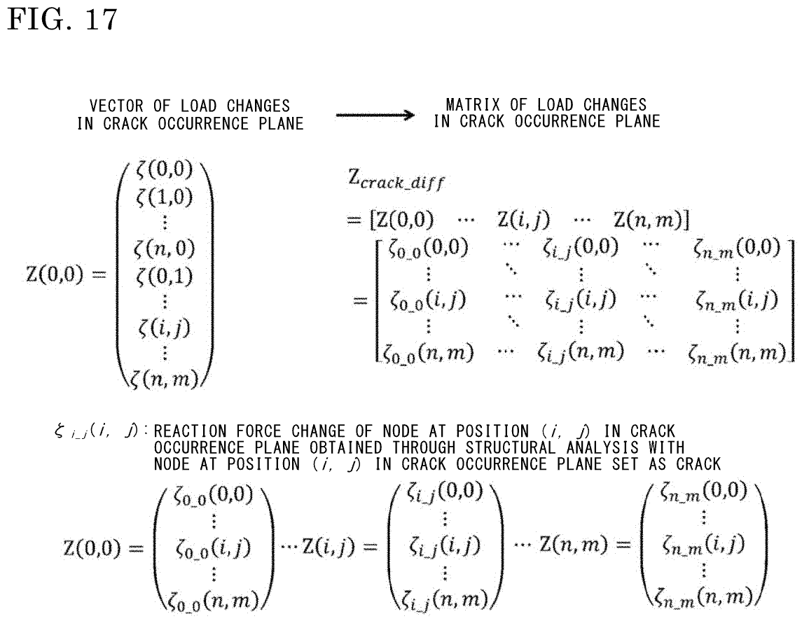

FIG. 17 shows a memory structure for storing information about vectors of load changes in the crack occurrence plane 02 according to embodiment 3.

Here, force change is used as a parameter in a matrix representing an analysis result for the crack occurrence plane 02, and in this case, only change in the method for generating the deformation vector for the observation plane 04 and the observation plane matrix will be described.

Instead of the vector Δ(0, 0) of displacement changes in the crack occurrence plane 02 shown in step S0205 in FIG. 9 or shown in FIG. 10, a column vector of a vector Z(0, 0) of load changes in the crack occurrence plane is used as shown in FIG. 17. In the column vector Z(0, 0), load data at nodes of the crack occurrence plane 02 are arranged in the determined order. In FIG. 17, ζ(i, j) represents a load of a node at a position (i, j) in the crack occurrence plane 02. Further, with information of a crack occurrence position for learning set as a position (i, j) in the crack occurrence plane 02, a column vector Z(i, j) is generated, and each element in the column vector Z(i, j) is represented by ζi_j(i, j). Here, ζi_j(i, j) represents a load of the node at the position (i, j) in the crack plane obtained through structural analysis with the node at the position (i, j) in the crack occurrence plane 02 set as a crack. Such column vectors are arranged in a row in the order of crack occurrence positions determined in step S01, to generate a crack occurrence plane matrix Z_{crack_diff} which is a matrix of load changes in the crack occurrence plane 02.

Also in the case where force change instead of displacement change is used as a parameter in a matrix representing an analysis result for the crack occurrence plane 02, it is possible to use not only strain change but also displacement change and angle change as deformation of the observation plane 04, thus obtaining the same effects as in embodiment 2.

As described above, by using the above means, operation for generating learning data corresponding to all shapes of cracks that can occur in a crack occurrence plane can be automated, and it is possible to estimate any internal crack position and size from changes in the observation plane while learning less crack data efficiently. Further, as a parameter in a matrix representing an analysis result for the crack occurrence plane, not only displacement change but also force change can be used. This is because a force on the node at the crack occurrence position is zero and forces act on the other nodes.

### Embodiment 4

In embodiment 1, it is required that deformation due to an internal crack has occurred at the observation plane at the time of inspection. Therefore, the target structure 01 is limited to a structure such as a shrink-fit part in which a force has been applied in advance. However, even in a case where no force has been applied to the target structure 01 in advance, if operation of applying a certain load to the target structure 01 is performed at the time of inspection and in a no-crack condition such as the time of determining learning data, the same measurement as described above can be performed.

Specifically, at the time of determining the learning data in step S01 in FIG. 2, a load to be applied to the target structure 01 and a position at which the load is applied are determined, and these are added to the boundary condition for structural analysis. Then, at the time of acquiring measurement data in step S03, the load to be applied, determined in the determination of the learning data, is applied at the load application position, and measurement is performed. Thus, it becomes possible to estimate the shape and the position of a crack even in a case where no force is applied in advance to the target structure 01 to be measured.

### Embodiment 5

In addition to performing inverse analysis for estimating the shape and the position of a crack, further inspection may be performed on the target structure 01, using the position and the size of the crack estimated in step S0404 in FIG. 12, an external force applied to a rotor structure during operation of an apparatus such as the turbine electric generator 100, and a physical property value of the material of the structure in which the crack has occurred, whereby the progress life for the crack may be calculated and the remaining apparatus usage period may be calculated. Thus, the remaining period in which the apparatus can be used can be recognized, whereby it becomes possible to repair and update the device in a planned manner. In the above description, a case of a turbine electric generator has been shown using embodiment 1 as an example, but the application example is not limited thereto.

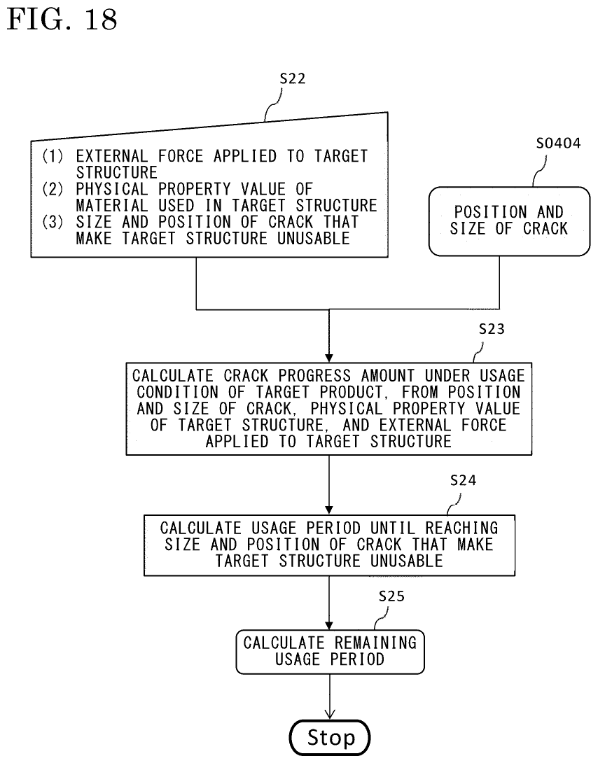

Specifically, as shown in FIG. 18, information shown in step S22 is added to information about the position and the size of a crack estimated in step S0404 in FIG. 12. Examples of the added information include (1) an external force applied to the target structure 01, (2) a physical property value of the material used in the target structure 01, and (3) the size and the position of a crack that make the target structure 01 unusable. Such information can be acquired at a stage of product designing, and is inputted through the input device 420 shown in FIG. 3, for example. In step S23, from the two sets of input information, i.e., the information estimated in step S0404 and the information inputted in step S22, a crack progress amount is calculated under the usage condition of the target apparatus such as the turbine electric generator having the target structure 01, on the basis of fracture mechanics. Calculation for the progress amount may not necessarily be based on fracture mechanics. The progress amount may be estimated on the basis of a result of time-series estimation of the size and the position of the crack. Further, in step S24, a usage period until reaching the size and the position of the crack that make the target structure 01 unusable, is calculated. Then, in step S25, the remaining usage period is calculated. The calculated usage period is outputted from the display device 430, and can be utilized for failure diagnosis on the apparatus.

### Embodiment 6

On the basis of the position and the size of a crack estimated in step S0404 in FIG. 12 and predetermined limit values for the size and the position of a crack in the structure, an alarm for urging stop of usage of the apparatus may be issued and failure diagnosis on the apparatus may be performed. Thus, it is possible to quickly determine to stop usage of the apparatus. The alarm is performed by the alarm device 410 shown in FIG. 3, for example.

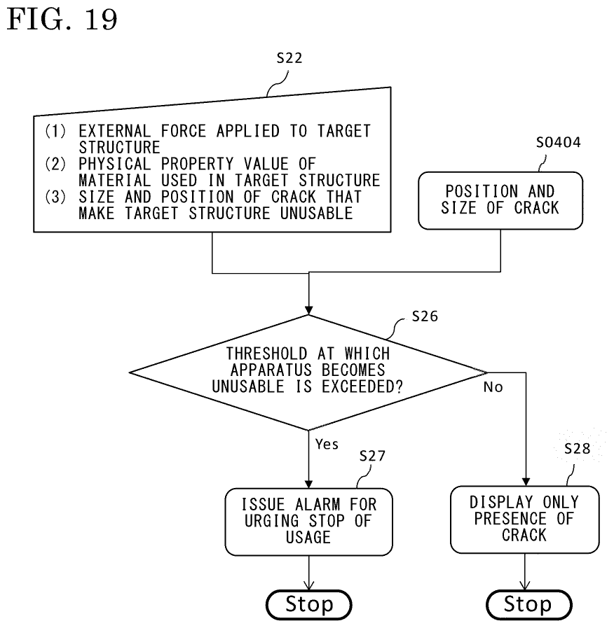

Specifically, as shown in FIG. 19, information shown in step S22 is added to information about the estimation values of the position and the size of a crack obtained in step S0404 in FIG. 12. Examples of the added information include (1) an external force applied to the target structure, (2) a physical property value of the material used in the target structure, and (3) the size and the position of a crack that make the target structure unusable. Such information can be acquired at a stage of product designing, and is inputted through the input device 420 shown in FIG. 3, for example. In step S26, from the two sets of input information, i.e., the information estimated in step S0404 and the information obtained in step S22, whether or not the size of the crack has exceeded a predetermined threshold at which the apparatus becomes unusable or will exceed the predetermined threshold within a predetermined period, is determined. If the size exceeds the predetermined threshold, an alarm for urging stop of usage is issued as shown in step S27. The alarm is performed by the alarm device 410 shown in FIG. 3, for example. If the size does not exceed the predetermined threshold, only information indicating presence of the crack is displayed on the display device 430 as shown in step S28. Further, in this case, the remaining usage period shown in embodiment 5 may be displayed together. Issuing an alarm as described above is useful for failure diagnosis on the apparatus.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

01 target structure
02 crack occurrence plane
03 crack
04 observation plane
100 turbine electric generator
200 rotor
300 measurement device
400 crack estimation device
401 processor
402 storage device
410 alarm device
420 input device
430 display device
4021 volatile storage device
4022 auxiliary storage device

1.-11. (canceled)

12. A crack estimation device comprising:
a data determinator which determines a shape model of a target structure to be inspected, and a crack occurrence plane and an observation plane in the shape model;
an estimation data calculator which outputs, as an estimation model for estimating a state of the crack occurrence plane from a state of the observation plane, an inverse matrix of a matrix that associates, with each other, the state of the crack occurrence plane and the state of the observation plane, obtained through numerical analysis of a structural analysis model generated from the shape model; and
a crack estimator which estimates a state of a crack at the crack occurrence plane on the basis of the estimation model and a measurement value for the target structure actually measured at the observation plane.

13. The crack estimation device according to claim 12, wherein
the matrix that associates the state of the crack occurrence plane and the state of the observation plane with each other in the estimation data calculator is a matrix that associates, with each other, a matrix in which the state of the crack occurrence plane is arranged in a predetermined order for each shape of the crack and a matrix in which the state of the observation plane is arranged in a predetermined order for each shape of the crack.

14. A crack estimation device comprising:
a data determinator which determines a shape model of a target structure to be inspected, and a crack occurrence plane and an observation plane in the shape model;
an estimation data calculator which outputs an estimation model for estimating a state of the crack occurrence plane from a state of the observation plane, on the basis of a matrix that associates, with each other, the state of the crack occurrence plane and the state of the observation plane, obtained through numerical analysis of a structural analysis model generated from the shape model; and
a crack estimator which estimates a state of a crack at the crack occurrence plane on the basis of the estimation model and a measurement value for the target structure actually measured at the observation plane, wherein
the estimation data calculator includes
a numerical analyzer which divides each of the crack occurrence plane and the observation plane into unit planes and performs numerical analysis of the structural analysis model on the basis of a boundary condition for the divided unit planes,
a numerical analysis controller which generates the structural analysis model from the shape model, sequentially sets such a boundary condition for the structural analysis model that a crack occurs at the crack occurrence plane, while analysis under the sequentially set boundary condition is sequentially performed by the numerical analyzer, and stores an analysis result of the crack occurrence plane and an analysis result of the observation plane in a storage device, and
an estimation data output circuitry which calculates a forward coefficient matrix for mapping a crack occurrence plane matrix in which the analysis result of the crack occurrence plane stored in the storage device is represented as a matrix, to an observation plane matrix in which the analysis result of the observation plane stored in the storage device is represented as a matrix, and outputs an inverse matrix of the forward coefficient matrix as the estimation model.

15. The crack estimation device according to claim 14, wherein
an input boundary condition which is the boundary condition for the structural analysis model is that, in the crack occurrence plane, connection between the divided unit planes of the crack occurrence plane is disconnected or displacement of the crack occurrence plane is changed to a shape or a boundary condition equal to a case where a crack has occurred.

16. The crack estimation device according to claim 14, wherein
the analysis result of the observation plane is represented as a vector based on any of displacement change, strain change, and angle change in the observation plane.

17. The crack estimation device according to claim 14, wherein
the analysis result of the crack occurrence plane is represented as a vector based on displacement change or load change in the crack occurrence plane.

18. The crack estimation device according to claim 12, wherein
the crack estimator calculates a displacement vector of the crack occurrence plane, from the inverse matrix and a deformation vector of the observation plane generated from a result of deformation of the target structure actually measured at the observation plane, and estimates a position and a size of a crack at the crack occurrence plane on the basis of the displacement vector.

19. The crack estimation device according to claim 12, wherein
the target structure is a shrink-fit part of a retention ring shrink-fitted to a rotor core at an end of a rotor of a rotary electric machine, and the shape model of the target structure is represented in a cylindrical coordinate system.

20. A crack estimation method comprising the steps of:
inputting a shape model of a target structure to be inspected, and a crack occurrence plane and an observation plane in the shape model;
outputting, as an estimation model for estimating a state of the crack occurrence plane from a state of the observation plane, an inverse matrix of a matrix that associates, with each other, the state of the crack occurrence plane and the state of the observation plane in a structural analysis model generated from the shape model; and
estimating a state of a crack at the crack occurrence plane on the basis of the estimation model and a measurement value for the target structure actually measured at the observation plane.

21. The crack estimation method according to claim 20, wherein
the matrix that associates the state of the crack occurrence plane and the state of the observation plane with each other is a matrix that associates, with each other, a matrix in which the state of the crack occurrence plane is arranged in a predetermined order for each shape of the crack and a matrix in which the state of the observation plane is arranged in a predetermined order for each shape of the crack.

22. The crack estimation method according to claim 20, wherein the step of outputting, as the estimation model includes
a step of performing numerical analysis while sequentially setting such a boundary condition for the structural analysis model that a crack occurs at every node between the divided unit planes of the crack occurrence plane, and storing an analysis result of the crack occurrence plane and an analysis result of the observation plane obtained through the numerical analysis, in a storage device, and
a step of calculating a crack occurrence plane matrix in which the crack occurrence plane is represented as a matrix and an observation plane matrix in which the observation plane is represented as a matrix from the analysis results stored in the storage device, calculating a forward coefficient matrix for mapping the crack occurrence plane matrix to the observation plane matrix, and outputting an inverse matrix of the forward coefficient matrix as the estimation model.

23. A crack inspection method comprising:
on the basis of a position and a size of a crack in a target structure estimated by the crack estimation method according to claim 20, an external force applied to the target structure, and a physical property value of a material used in the target structure, calculating a progress life for the crack, and calculating a remaining period until an end of the progress life.

24. A failure diagnosis method comprising:
on the basis of a position and a size of a crack in a target structure estimated by the crack estimation method according to claim 20, an external force applied to the target structure, and a physical property value of a material used in the target structure, if it is determined that the size of the crack has exceeded a predetermined threshold or will exceed the threshold within a predetermined period, issuing an alarm.
